(19) United States
(12) Patent Application Publication
(10) Pub. No.: US 2019/0179426 A1
(43) Pub. Date: Jun. 13, 2019

(54) SYSTEM AND METHODS FOR COMMUNICATIONS IN MIXED REALITY APPLICATIONS

(71) Applicant: PCMS Holdings, Inc., Wilmington, DE (US)

(72) Inventor: Pasi Sakari Ojala, Kirkkonummi (FI)

(21) Appl. No.: 16/325,606

(22) PCT Filed: Aug. 17, 2017
(86) PCT No.: PCT/US2017/047419

§ 371 Date: Feb. 14, 2019

Related U.S. Application Data
(60) Provisional application No. 62/377,210, filed on Aug. 19, 2016.

(51) Int. Cl. G06F 3/03; H04B 10/116; G09G 5/37; G09G 5/38; G06F 3/01

(52) U.S. Cl. CPC G06F 3/0304; H04B 10/116; H04B 10/502; G09G 5/38; G06F 3/011; G09G 5/37

(57) ABSTRACT

Systems and methods are provided for the use of proxy objects in augmented reality and virtual reality environments. In an exemplary embodiment, a proxy object emits a temporally-modulated light signal, and the signal is detected at a user's head-mounted display. The light signal is decoded to identify which virtual object is intended to be represented by that proxy object. The location of the proxy object is tracked, and the identified virtual object is rendered on the head-mounted display at a position corresponding to the position of the proxy object. Depending on the light signal emitted by the proxy object, the same object may appear to a user at different times to be a paint brush, a weapon, a torch, or other virtual object.

### CROSS-REFERENCE TO RELATED APPLICATIONS

The present application is a non-provisional filing of, and claims benefit under 35 U.S.C. § 119(e) from, U.S. Provisional Patent Application Ser. No. 62/377,210, filed Aug. 19, 2016, and entitled “System and Methods for Communications in Mixed Reality Applications,” the entirety of which is incorporated herein by reference.

### BACKGROUND

Some mixed-reality services employ wearable devices with immersive audio, sensor arrays, and/or multiple cameras for capturing a three-dimensional (3D) environment and representing augmented audio/visual content in 3D. With a wearable device, a service user may be able to experience a mixture of a real environment and an augmented environment and communicate with other service users.

Some mixed-reality wearable devices include head mounted goggles and a mounting device for a smartphone. For example, the Samsung Gear VR® powered by Oculus device connects a Samsung® smartphone (e.g., Samsung Galaxy® S7, Samsung Galaxy® Note 5, among others) as a stereoscopic display. Generally, a smartphone has a camera for recording a view and/or one or more microphones for capturing audio. The mixed reality experience may be realized by rendering the audio/visual content with headphones and the smartphone's display.

Some wireless networks enable communication between individual devices within a mesh network configuration, which may allow for use of a mixed-reality service, for example, by one or more persons in an environment (e.g., a predetermined location). Such wireless networks may enable network users to share data and/or have one or more conversations with each other.

### SUMMARY

Systems and methods are presented for mixed-reality applications and communications in the same. Exemplary systems and methods may provide for sharing location, orientation, motion, and other contextual information of an object for rendering the object in a mixed-reality application.

Each object and/or each user in the mixed-reality service may be equipped with one or more light-emitting elements capable of transmitting data using a Li-Fi (“Light Fidelity”) and/or one or more other modulated-light data transmission techniques for communicating data to one or more devices, such as, for example, one or more head-mounted displays (HMDs) worn by one or more users (e.g., other service users). A head-mounted camera of the service user may capture the environment and/or may detect one or more Li-Fi transmissions simultaneously. A Li-Fi receiver may extract these signals from the video stream and may decode the corresponding messages. With the received contextual data, the mixed-reality service application may be able to render an appropriate virtual object corresponding to the physical (real-world) object.

In some embodiments, a modulated light signal (e.g., a Li-Fi signal) sent by an object provides information on the location and/or orientation of the object. In some embodiments, the modulated light signal provides rendering instructions of the object (e.g. parameters such as RGB or other color data, information on polygon vertices for rendering the object, texture data for rendering the object, and the like). In some embodiments, the Li-Fi transmitted signal may contain only an identifier of the object, and the identifier may be used to look up the appropriate rendering parameters. The location at which the transmitted light is detected may provide information about the location of the corresponding object. In at least some such embodiments, the object identifier is applied to request relevant information instructions from a service database.

### BRIEF DESCRIPTION OF THE DRAWINGS

FIG. 1 is a block diagram of an exemplary light-pattern emitting proxy object, in accordance with some embodiments.

FIG. 2 illustrates an overview of an exemplary scenario including a light-pattern emitting proxy object and a video camera.

FIG. 3 is a flow chart of an exemplary method for rendering a virtual object corresponding to a real-world object in a mixed-reality service in accordance with some embodiments.

FIG. 4. illustrates an overview of an exemplary scenario including a light-emitting element that is mounted to an object and is broadcasting a visible light signal to two devices in a mixed-reality service.

FIG. 5 illustrates a simplified example of fountain coding for splitting a message into blocks which are combined together as symbols for transmission as drops in accordance with some embodiments.

FIG. 6 is a flow diagram of an exemplary data flow/data processing that may be used for rendering a mixed reality object on a service user's display, in accordance with some embodiments.

FIG. 7 illustrates four exemplary virtual-reality-object renderings, each including a virtual-reality object corresponding to the same real-world object in a mixed-reality service, in accordance with some embodiments.

FIG. 8 illustrates an embodiment in which the image of the actual physical object on the camera view is replaced with a virtual object having an artificial shape and texture.

FIG. 9 is a block diagram of an exemplary wireless transmit receive unit (WTRU) that may be employed as an exemplary augmented reality (AR) and/or virtual reality (VR) display device.

### DETAILED DESCRIPTION

Some mixed-reality techniques apply visual motion capture of service users and a surrounding environment. For example, the Artanim mixed-reality game (Charbonnier, Caecilia and Vincent Trouche. “Real Virtuality White Paper,” Aug. 23, 2015) applies a video stream captured by a user's headset to estimate one or more locations, one or more movements and/or, one or more poses of users of the mixed-reality game. An application uses cameras that determine the position and orientation of different objects. This information is applied to render and augment the environment, objects, and users in the mixed-reality presentation.

Visible markers may provide information by marking a location and/or orientation of an object. An example of a visible marker is a quick-response (QR) code that may be attached to one or more physical objects and may be detected via a camera application. The QR code may be used to provide information (e.g., to the camera application and/or a device in communication with the camera application).

Some mixed-reality services may render real-world objects as artificial or animated avatars. To operate effectively, some mixed-reality services may acquire or determine relative location and/or orientation information of a real, physical object and a desired rendering scheme. These mixed-reality services may employ several visible markers (even on a simple physical object) to explicitly determine a location, an orientation, or movement of an object. For example, visible markers, such as light sources or light reflectors, may be placed on objects so that the mixed-reality service, via an application employed for detecting the visible markers with a camera, is able to determine the object's location and/or orientation. In some scenarios, stereo video with two or more view angles is employed to be able to determine accurate location and orientation. In some scenarios, if each of the visible markers on the object is not visible to the camera, the camera application may not be able to obtain or determine accurate measurements of the device's location or orientation and may not be able to render a corresponding virtual object in the correct location or with the correct orientation. For example, if the marker is not within the camera's field of view, the augmented-reality application (e.g., using a rendering tool) may not be able to trace the object's movement, the object's orientation, or the object's dimensions. As a result of not being able to accurately obtain or determine such measurements or to accurately render the object in the correct location or orientation, presentation of the mixed-reality experience may be compromised.

In addition, the mixed-reality application may not be able to receive additional information regarding the visible objects or the users via detection of passive visual markers that are employed for determining a location, an orientation, or movement of an object. For example, the identity of the object is not available. Further, in such scenarios, introducing new objects that are unknown to the service beforehand may not be feasible. In such situations, the object or the other user may be recognized only based on the location and orientation of the visible markers (e.g., based on the detected shape and motion).

If the mixed-reality service does not receive from an object any information corresponding to the desired appearance, texture, and/or possible effects (e.g., for rendering the object in the mixed-reality environment), then, in some scenarios, the object may be seen in the mixed-reality environment as the object is seen in the real world.

Systems and methods disclosed herein may employ a head-mounted display to render a virtual object on the head-mounted display based on a temporally-modulated light signal emitted from a light-pattern emitting proxy object. The light-pattern emitting proxy object may include one or more light-emitting elements (e.g., which may include one or more LED-based transmitters), which may transmit modulated light that conveys contextual information and/or relevant instructions (e.g., rendering instructions) to one or more entities in a mixed-reality service. The light-emitting element may be mounted on an (real-world) object and/or a user of the mixed-reality service. The light-emitting element may transmit the object's and/or the user's identity (e.g., an object identifier/identity code), may transmit instructions for rendering on the screen (or other display) a virtual object corresponding to the object and/or the user, and/or may transmit instructions as to how the object and/or the user interacts within the service.

In some embodiments, a light-emitting element of a light-pattern emitting proxy object is mounted on a user and/or object in a mixed-reality service. The light-emitting element may employ an active light source (e.g., a light source such as an incandescent light bulb, a light-emitting diode (LED), a compact fluorescent light bulb, a halogen light bulb, etc., that may change and/or maintain its state). The active light source of the light-emitting element may be modulated so as to transmit contextual information regarding the corresponding object and/or the corresponding user. Accordingly, the light-emitting element transmits a coded message, for example, instead of only being used to pin-point a 3D coordinate in space. The light-emitting element may employ any suitable visible light communication (VLC) technology. In one embodiment, the light-emitting element employs light fidelity (Li-Fi) technology for transmitting one or more messages to the one or more entities of the mixed-reality service. Technology that may be used in exemplary embodiments for visible light communication (VLC) of data between two or more devices includes the technology described in Published U.S. Patent Application No. US20130208184.

Some exemplary embodiments address the problems of varying proxy-object characteristics in different games (e.g., different mixed-reality games) and/or in a game at different levels of the same game. To address these problems, in some exemplary embodiments, a real-world object that is to be mapped to a proxy object is instrumented with only a VLC source (e.g., light bulb or LED); the VLC source is programmed to transmit different light patterns to indicate varying proxy-object characteristics to be rendered. For example, the VLC source may be programmed to transmit a first light pattern that indicates the real-world object is to be rendered as a sword, a second light pattern that indicates the real-world object is to be rendered as a torch, and a third light pattern that indicates the real-world object is to be rendered as a bow.

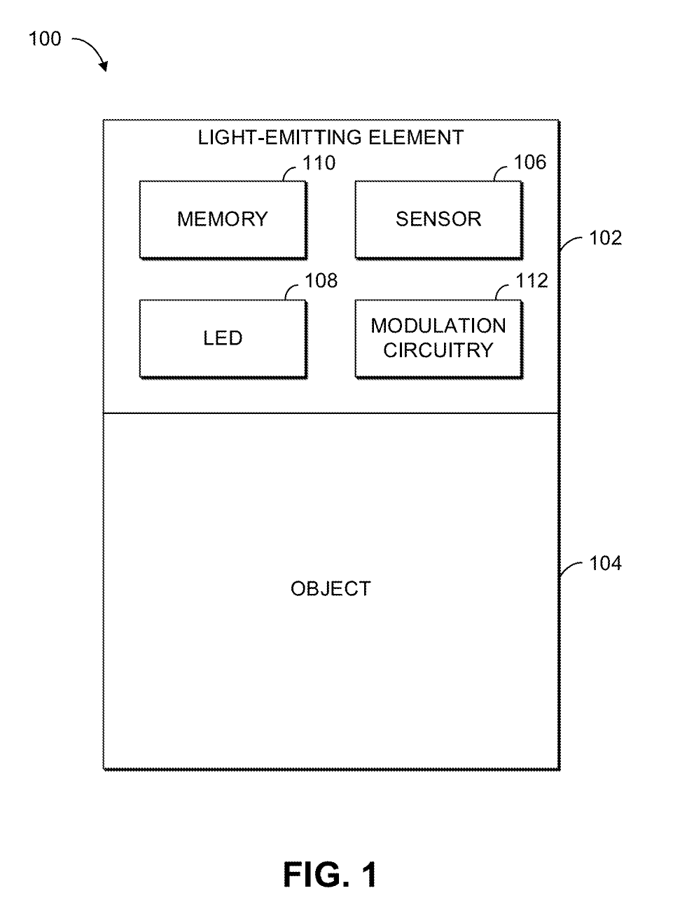

FIG. 1 is a block diagram of an exemplary light-pattern emitting proxy object 100. The exemplary light-pattern emitting proxy object 100 includes an exemplary light-emitting element 102 and an exemplary object 104. In some embodiments, the light-emitting element 102 is mounted on the object 104. In some embodiments, the light-emitting element 102 is a part of the object 104. For example, the light-emitting element 102 may be embedded in a body of the object 104. The exemplary light-emitting element 102 may be mounted on the (real-world) object 104 to enable transmission of contextual information corresponding to the object 104 to one or more entities (e.g., head-mounted displays (HMDs)) of a mixed-reality service (e.g., a mixed-reality game which includes one or more users/players wearing corresponding HMDs). Although the light-emitting element 102 is described as being mounted to the object 104, this description is equally applicable to describe a light-emitting element 102 that is mounted to a user.

The proxy object 100 may emit a temporally-modulated light signal, which may be detected at a head-mounted display. The light-signal may be decoded to identify a virtual object indicated by the light signal. A location of the proxy object 100 may be tracked. The identified virtual object may be rendered on the head-mounted display at a position corresponding to the proxy object 100.

In the exemplary embodiment of the light-emitting element 102 illustrated in FIG. 1, the light-emitting element 102 includes a sensor 106, a light-emitting diode (LED) 108, memory 110, and modulation circuitry 112. The LED 108 may be modulated by the modulation circuitry 112 in such a way that the LED 108 transmits one or more coded messages, for example, which may be received by the one or more entities. The modulation circuitry 112 may be configured to employ any suitable modulation scheme for modulating the LED 18 to enable transmission of the one or more coded messages. For example, the modulation circuitry 112 may be configured to employ frequency shift keying, phase shift keying, on-off keying, amplitude modulation, and the like. The LED 108 may emit a temporally-modulated light signal. For example, the modulation circuitry 112 may modulate the LED 108 by switching the LED 108 on and off according to a temporal pattern. The LED 108 may be modulated by the modulation circuitry 112, for example, at a rate such that the modulation is imperceptible to the human eye. In some embodiments, the LED 108 is modulated by the modulation circuitry 112 based on contextual information corresponding to the object 104 that is stored in the memory 110 and/or measured by the sensor 106. In some embodiments, the LED 108 is modulated by the modulation circuitry 112 based on other information (e.g., characteristic data of the surrounding environment, user input data, etc.).

For example, the light-emitting element 102 may receive user input data from a user interacting with the object 104. The user may input user-input data via one or more mechanisms, such as, for example, a switch, a knob, a dial, a button, trigger, a touchpad, and the like. Additionally or alternatively, the user may input user-input data via speech, a gesture, a sound, and the like. The light-emitting element 102 may receive the input user-input data from the user, and the modulation circuitry 112 may responsively modulate the LED 108 based on the input user-input data. For example, the input user-input data may be indicative of a virtual object selection, and the modulation circuitry 112 may modulate the LED 108 based on data corresponding to the virtual object selection. For example, the user may be presented with one or more options of virtual objects and/or virtual object characteristics that the user may select. Additionally or alternatively, a mixed-reality user application may receive one or more options of virtual objects and/or virtual object characteristics. The mixed-reality user application may be running on the light-emitting element 102 or an HMD worn by the user. The HMD worn by the user may receive the one or more options of virtual objects and/or virtual object characteristics as one or more temporally-modulated light signals emitted from the light-emitting element 102. The mixed-reality user application may determine to render a virtual object selected from and/or based on the one or more options of virtual objects and/or virtual object characteristics. The mixed-reality user application may automatically select (e.g., without user input) a virtual object to render for the object 104. The mixed-reality user application may determine a rendering scheme to use to render a virtual object based on the one or more options of virtual objects and/or virtual object characteristics. As an example, the mixed-reality user application may receive a virtual torch, a virtual flashlight, and a virtual lantern, and from these options, the mixed-reality user application may determine to render a virtual torch. The mixed-reality user application may determine to render that virtual object (as opposed to other virtual objects) based on a setting of the application, a game characteristic (e.g., a game genre, a game level, a game skill level, a game-level skill level, a game environment type, etc.), a user characteristic (e.g., a user skill level, a user age, etc.), state data, object identifier data, sensor data, and/or any other suitable settings, characteristics, and/or other data. For example, the mixed-reality user application may determine to: render the virtual torch when the mixed-reality user application is rendering a virtual cave; render the virtual flashlight when the mixed-reality user application is rendering a virtual basement; and render the virtual lantern when the mixed-reality user application is rendering a virtual graveyard. The virtual cave, the virtual basement, and the virtual graveyard, for example, may correspond to different levels of the same game or different levels of different games. As another example, the mixed-reality user application may determine to render a virtual flame thrower when the user is a low skill level and may determine to render a virtual bow-and-arrow when the user is a high skill level.

In some embodiments, the light-pattern emitting proxy object includes a user interface configured to present the one or more options of virtual objects and/or virtual object characteristics. In some embodiments, the HMD presents one or more options of virtual objects and/or virtual object characteristics. The user may, for example, cycle through an inventory of options of virtual objects and/or virtual object characteristics from which the user may select for rendering. For example, a user may press a button that causes a description of a virtual object to be presented and may press the button again to present a description of a different virtual object. For example, a user may press a button to cause a description of a first virtual gun (a musket) to be presented, and the user may press the button to cause a description of a second virtual gun (a shotgun) to be presented. A description of a virtual object may be presented as text, an image, a video, audio, etc. For example, the description of the first virtual gun may include an image including (or describing) a musket, a video including (or describing) a musket, audio including (or describing) a musket, etc. After being presented with one or more options of virtual objects and/or virtual object characteristics, the user may select a virtual object. Based on the virtual object selection, the modulation circuitry 112 may modulate the LED 108. A virtual object may be rendered (e.g., by an HMD worn by the user that receives a VLC signal from the light-emitting element 102), based on the virtual object selection. In some embodiments, the proxy object 100 switches from emitting a first light signal to emitting a second light signal in response to a user input on the proxy object 100.

In some embodiments, the memory 110 stores an object identifier corresponding to the object 104 to which the light-emitting element 102 is mounted, and the object identifier is transmitted in a coded message via the LED 108, for example, as described above. The object identifier may be transmitted by the LED 108 to enable the one or more entities to render (e.g., after decoding a coded message including the object identifier) a virtual object having one or more visual characteristics that are selected based on the object identifier. For example, the object identifier may correspond to characteristics of a (real-world) stick to which the light-emitting element 102 is mounted, and the object identifier may correspond to a set of one or more visual characteristic data that may be received (e.g., via the coded message transmitted by the LED 108) by the one or more entities. In this illustrative example, the set of one or more visual characteristic data corresponding to the (real-world) stick enables the one or more entities to render, in a mixed-reality baseball game, a virtual baseball bat corresponding to the (real-world) stick. As a result of the LED 108 being modulated to transmit a coded message including the object identifier, in this illustrative example, the one or more entities (e.g., one or more HMDs worn by respective players of the mixed-reality baseball game) that receives the coded message including the object identifier retrieves the corresponding set of one or more visual characteristic data and renders a virtual baseball bat.

In some embodiments, the memory 110 stores other characteristic data. This characteristic data may correspond to any number of characteristics that enable suitable rendering of a virtual object (e.g., a rendering scheme of the object) corresponding to the object 104 to which the light-emitting element 102 is mounted.

In some embodiments, the light-emitting element 102 includes an accelerometer and/or a gyroscope to enable transmission of location and/or orientation information regarding the corresponding object. In some embodiments, other suitable sensors for measuring location and/or orientation of an object may be employed.

The light-emitting element 102 may be programmed to transmit a VLC signal based on predetermined data. For example, the light-emitting element 102 may store an object identifier in the memory 110 or may have access to the object identifier in remote storage, and the light-emitting element may be programmed to transmit a VLC signal based on the stored object identifier. The light-emitting element 102 may be programmed to transmit a VLC signal based on data acquired in real-time, for example, by the sensor 106. The light-emitting element 102 may be programmed to maintain state data that may be indicative of a state of a virtual object that corresponds to the real-world object. For example, the light-emitting element 102 may maintain state data for a virtual object that is a torch, and the state data may be indicative of an amount of fuel left in the torch. As another example, the light-emitting element 102 may maintain state data for a virtual object that is a gun, and the state data may be indicative of an amount of remaining ammunition. The light-emitting element 102 may be programmed to transmit a VLC signal based on the state data. The transmitted VLC signal may encode the state data.

In an exemplary scenario, an HMD is presenting a mixed-reality experience (e.g., a virtual-reality experience or an augmented-reality experience), in which a user wearing the HMD uses a virtual torch to navigate a virtual cave. The virtual torch is rendered based on a VLC signal transmitted from a light-emitting element mounted on a real-world object, which the user wearing the HMD is interacting with during the presentation of the mixed-reality experience. The user exits the virtual cave, and no longer desiring to use the virtual torch, the user puts down the virtual torch. Subsequently, the user returns to the virtual cave and picks up the virtual torch. The HMD detects a VLC signal transmitted from the light-emitting element mounted to the real-world object. The transmitted VLC signal encodes state data maintained by the light-emitting element and corresponding to the virtual torch. Because the user already used the torch the first time the user was in the cave, the amount of fuel the torch has available for use the second time the user is in the cave is less than the amount of fuel the torch has available for use the first time the user was in the cave. When the user is in the cave the second time, the HMD may render the virtual torch with a flame that is not as bright, large, etc., as the flame when the virtual torch was rendered when the user was in the cave the first time (when the torch had more fuel). The HMD may render the virtual torch with less fuel based on the state data that may be maintained by the proxy object. For example, the proxy object may be configured to maintain state data that is based on use-time data (e.g., a time the proxy object is used and/or not used by one or more users), movement data (e.g., an amount of movement of the proxy object over a period of time) of the proxy object, speed/velocity data of the proxy object, acquisition data (e.g., a number of occurrences that the proxy object has been used, acquired, picked up, dropped, traded, discarded, etc.), acceleration data of the proxy object, location data of the proxy object, orientation data of the proxy object, and/or any other suitable data.

In some embodiments, a mixed-reality service includes one or more headsets equipped with visual overlay goggles that are worn by corresponding users. In some embodiments, a user may only see the environment as presented by the headset, which may present images of the environment that are captured via the camera view of a head-mounted camera of the headset. The mixed-reality service may render the environment with artificial shapes and/or textures and/or may modify the real-world objects and/or real-world sound sources with artificial content, for example, according to a game plan that may be implemented by the mixed-reality service. The environment, the one or more objects, and/or the one or more users may be identified and/or located via the corresponding light-emitting elements to enable the mixed-reality service (e.g., the one or more headsets of the mixed-reality service) to render the environment, the one or more objects, and/or the one or more users.

The head-mounted camera may be able to detect (e.g., simultaneously detect) one or more light-emitting elements, each of which are emitting a coded message. The position of the light-emitting element on the camera view may be captured, and the corresponding Li-Fi signal may be decoded. As the message may contain contextual information regarding the physical object to which the light-emitting element is attached or otherwise coupled, in some embodiments, the mixed-reality service, via the mixed-reality application, renders a virtual object that corresponds to the physical object in a correct position in relation to the position of the receiver and the position of the light-emitting element in the camera view.

When the light-emitting element attached on the object or user is transmitting location and orientation information, there may be no need to triangulate the relative position based on the position of the light-emitting element as detected on the video stream. Instead, the light-emitting element may convey such information itself by emitting a coded message that includes such information. In such situations, when triangulation may not be necessary, there also may not be a need for stereo cameras. For example, only one camera may be used to trace the object and/or receive the visual code. Furthermore, a single camera may be able to receive several visual codes from several objects simultaneously. In some embodiments, the one or more entities includes a camera for identifying the position of the light-emitting element on the video stream captured by the camera and includes sensor hardware configured to receive and/or decode data transmitted by the light-emitting element. Identifying the position of the light-emitting element with the camera may enable rendering of the object at an appropriate point of view. In some of these embodiments, the camera captures the light signal that is embedded with the object identifier (e.g., of a low bit rate), and the sensor hardware that is configured to receive data at higher transmission rates (e.g., gigabit transmission rates) detects other object data which is modulated on a different frequency domain. For example, the sensor hardware may be a high-speed photodetector and analog-to-digital converter.

The light-emitting element (e.g., a Li-Fi light source of the light-emitting element) may be configured to transmit additional contextual information, such as overall shape data of the object and/or motion data of the object, as well as instructions for rendering of the object. The visual code that is transmitted may encode sensor information about the object, such as, for example, information regarding the shape and/or motion of the object.

Alternatively, the Li-Fi transmitted message (visual code) may contain only an object identifier (e.g., a low bit rate object identifier), in which case the receiver may request the related contextual information from the service database(s). In this case, objects may be predetermined, and information corresponding to predetermined objects may be mapped to that object's object identifier. The information may be stored (e.g., in a server). In this case, the Li-Fi transmitted message encodes the object identifier, so the Li-Fi transmitted message may be received and then decoded to obtain the object identifier. With the object identifier, the information corresponding to the object that is mapped to the object identifier may be retrieved and used.

In scenarios where a sufficient amount of data is transmitted by the light-emitting element, even a priori unknown objects with their individual rendering instructions may be encountered in the service environment. After receiving the sufficient amount of data transmitted by the light-emitting element, the mixed-reality service may be enabled to render such objects based on the received sufficient amount of data.

In some scenarios, the light-emitting element, which may transmit messages via a Li-Fi signal, may be visible to more than one camera application simultaneously. In some embodiments, the transmitted contextual message is a real-time point-to-multipoint stream. In some embodiments, fountain code based rateless coding is employed, which may result in more efficient data transmission. In some of the embodiments that employ such coding, the resulting robust data transmission allows the camera application to be able to trace the object even if the camera's line of sight to the light-emitting element is occasionally broken.

In some embodiments, some of the one or more (real-world) objects of the mixed-reality service may not be connected to other entities of the mixed-reality service. In such embodiments, the one or more real world objects may communicate with other entities of the mixed-reality service by transmitting (broadcasting) contextual information and/or rendering instructions to the other entities of the service. If an object that the mixed-reality service is without prior knowledge appears in the service area, finding a physical backchannel may not feasible. In addition, there may be several entities (e.g., one or more objects and/or user devices receiving the signal). The object may cast the contextual information to all service users (e.g., to AR/VR display devices worn by respective service users) having a line of sight to the object. Serving every receiver of each respective entity in the mixed-reality service with retransmissions may not be feasible. Employing fountain code based coding may be useful in such a situation since there may be no backchannel for requesting retransmission or feedback.

Modulating the light-emitting element's transmission of one or more visible light signals may enable transmission of object characteristic data (e.g., transmission of coded messages via a visible light signal) capabilities and may enable (real world) object location determination based on a transmitted visible light signal. For example, based on modulating the light-emitting element 102 (e.g., adjusting a pulse-rate of the LED 108), the camera application may be able to determine the location of the corresponding object in the video stream captured by the camera (e.g., which may be a starting point for rendering the object), and the data transmission that may be received with the same camera application or with special detector hardware may provide information for a rendering scheme of the object.

Li-Fi transmission may be employed for point-to-multipoint communication. That is, all the receivers that see the transmitter, namely the LED of the light-emitting element attached to the object, may get the message. In some embodiments, when the camera view is directed away from a physical object (which may be indicative of the mixed-reality user's interest in the physical object), the object is not visible any more, and there is no need to render the corresponding virtual object on the screen. In that case, the transmission may also be cut, and there may be no need to continue decoding the messages.

In some embodiments, a real-world object may be “brought to life” via the mixed-reality service based on a visual code transmitted via the light-emitting element and containing relevant context information and/or rendering instructions. Based on the visual code, the mixed-reality service may augment presentation of visual characteristics/effects of the real object, such as, for example, the object's texture, shape, size, color, etc., and/or animations of the object. A priori unknown objects with new features and/or unseen functionalities can be introduced in a mixed-reality game when the object itself is able to transmit the relevant information.

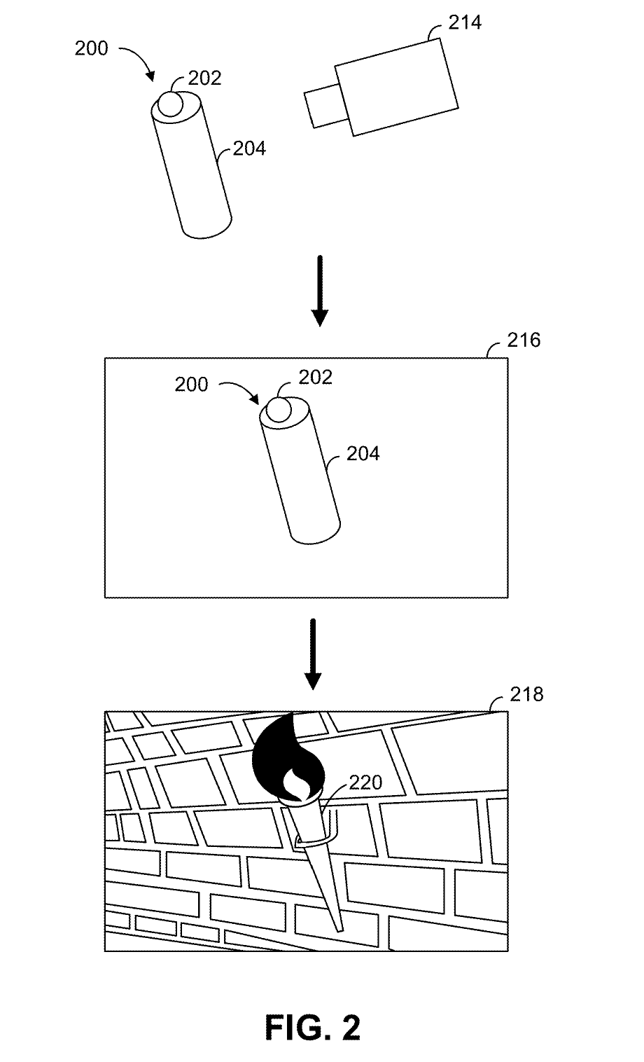

FIG. 2 illustrates an overview of an exemplary scenario including a light-pattern emitting proxy object and a video camera. The light-pattern emitting proxy object 200 includes a light-emitting element 202 and a real-world object 204. The light-emitting element 202 is attached to the real-world object 204 and is capable of emitting a coded message. In the exemplary scenario illustrated in FIG. 2, the real-world object 204 is a stick-shaped real-world object. Sensors associated with the light-pattern emitting proxy object 200 (e.g., coupled to the proxy object, embedded within the proxy object) may be configured to determine a location and/or orientation of the object 204 (e.g., using a GPS receiver and/or one or more gyroscope sensors). A VLC communication technology, such as, for example, Li-Fi, may be employed so that the proxy object 200 may transmit a coded location/orientation message as a visible light signal that can be detected with the video camera 214. The coded location/orientation message may include the location and/or orientation of the object measured by the sensors. The coded location/orientation message may take the form of a temporally-modulated light signal.

The video camera 214 may be worn on a head of a user. The video camera 214 may be associated with an HMD that may be worn by the user. The HMD may include the functionality of the video camera 214 or may be communicatively coupled to the video camera 214. A camera application may pick up (receive) the stream of images/video captured by the camera 214 from the camera view and/or may detect the light-emitting element 202. An example camera view of the camera 214 is shown at 216. Using the camera 214, a temporally-modulated light signal emitted from the proxy object 200 may be detected. A location of the light-emitting element 202 on the screen may be traced (e.g., by the camera application), and the received Li-Fi transmission may be recorded and/or decoded. This information may then be applied to select correct texture and/or visual effects for rendering the real-world object 204 (e.g., augmenting the image of the real-world object that is captured by the video camera 214). The mixed-reality application may then render a mixed-reality object overlay on top of the video stream including the captured physical object (e.g., the stick). As shown at 218 in FIG. 2, the (real) object 204 is rendered as a virtual torch 220.

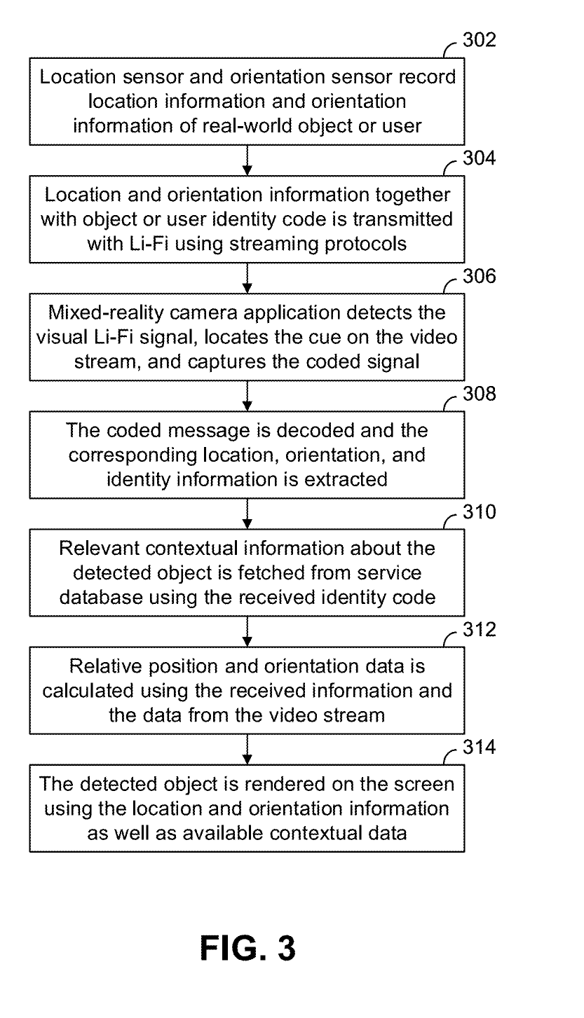

FIG. 3 is a flow chart of an exemplary method for rendering a virtual object corresponding to a real-world object in a mixed-reality service (e.g., for rendering the virtual torch shown in FIG. 2). In some embodiments, the transmitted VLC signal (e.g., transmitted by Li-Fi) contains the location and orientation information of the real-world object and contains the object's identity code. The receiver may apply the code to request other relevant information about the object from a service database. In some embodiments, the coded Li-Fi message also contains information corresponding to a desired rendering scheme, an artificial shape of the virtual object, texture, possible visual effects, etc. In some of the embodiments employing a coded Li-Fi signal that includes this information, the mixed-reality service does not determine or obtain such information for an actual physical object of and/or a user of the mixed-reality service a priori. In such embodiments, the object and/or the user introduced in the service may define the context independently and/or may change the context during the mix-reality service (e.g., a game).

In step 302, a location sensor and an orientation sensor record location information and orientation information, respectively, of a real-world object or a user. For example, a location sensor and an orientation sensor may be coupled to a light-pattern emitting proxy object that includes a real-world object and a light-emitting element. The location sensor and the orientation sensor may be configured to measure location information and orientation information of the real-world object of the light-emitting proxy object.

In step 304, the location information and the orientation information, together with the object identity code (or user identity code), are transmitted with Li-Fi using one or more suitable streaming protocols.

In step 306, a mixed-reality camera application detects the visual Li-Fi signal, locates the cue on the video stream, and captures the coded signal. For example, a camera may capture an image(s)/video of the proxy object.

In step 308, the coded message is decoded and the corresponding location, orientation, and identity information is extracted.

In step 310, relevant contextual information about the detected object is fetched from a service database using the received identity code.

In step 312, relative position data and relative orientation data is calculated using the received location information, the received orientation information, and the data from the video stream.

In step 314, a virtual object is rendered on the screen using the location information and the orientation information, and the contextual data. For example, the video stream with an overlaid mixed-reality object may be presented to the service user. The application may overlay the rendered object on top of the physical object on the video screen.

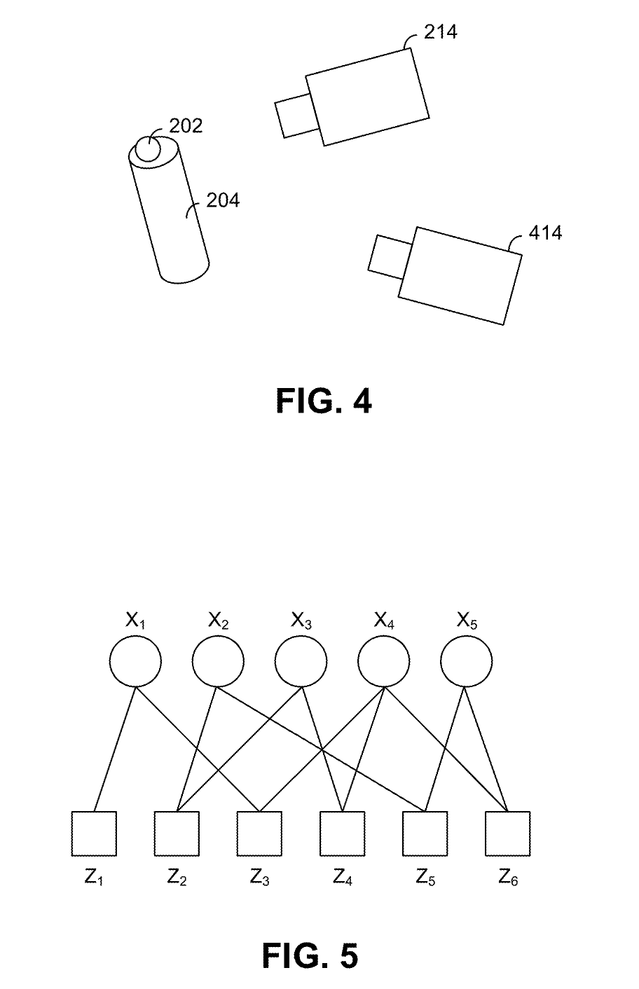

As shown in FIG. 4, in some embodiments, a Li-Fi transmitter of a light-emitting element 202 that is attached to or mounted on a physical object (real-world object) 204 is visible to more than one camera of a corresponding user device simultaneously. As shown in FIG. 4, the light-emitting element 202 is in respective lines of sight of the camera 214 and a camera 414. In such embodiments, because the Li-Fi signal is visible to each device (e.g., a camera of each device) having a line of sight to the Li-Fi transmitter, the data (e.g., the coded message) is broadcasted to each of these devices simultaneously/automatically. To support such a point-to-multipoint data transmission, relevant protocols may be employed.

In some embodiments having more than one mixed-reality application receiving the Li-Fi transmission, the employed protocol supports efficient data streaming. For example, employing fountain codes may allow for efficient data streaming. Fountain codes enable rateless coding and may enable messages to be received without employing acknowledgement signaling and/or retransmission requests.

Generally, fountain code encoding may be described as encoding that combines “blocks” of a message (e.g., with an XOR procedure) and that transmits the blocks as “drops.” FIG. 5 presents a simple example of splitting a message into blocks (blocks Z₁-Z₆) which are combined together as symbols for transmission as drops (drops X₁-X₅).

The fountain code may be decoded by, for example, collecting the received symbols, composing an encoding graph (such as the encoding graph shown in FIG. 5) into matrix format, and solving the set of linear equations. Equation (1) represents the encoding equations for the simple fountain code example illustrated in FIG. 5.

$$[ \begin{matrix}1 & 0 & 0 & 0 & 0 \\ 0 & 1 & 1 & 0 & 0 \\ 1 & 0 & 0 & 1 & 0 \\ 0 & 0 & 1 & 1 & 0 \\ 0 & 1 & 0 & 0 & 1 \\ 0 & 0 & 0 & 1 & 1\end{matrix} ] [ \begin{matrix}{X}_{1} \\ {X}_{2} \\ {X}_{3} \\ {X}_{4} \\ {X}_{5}\end{matrix} ] = [ \begin{matrix}{Z}_{1} \\ {Z}_{2} \\ {Z}_{3} \\ {Z}_{4} \\ {Z}_{5} \\ {Z}_{6}\end{matrix} ] \qquad Equation ( 1 )$$

In this example, the transmitter keeps casting the symbols Zᵢ. The fountain-code decoder may be responsible for collecting as many transmitted symbols Zᵢ as is feasible and/or solving for Xᵢ of the Equation (1). In some embodiments, because the fountain is transmitting redundant copies of the symbols, at some point during transmission, the receiver has collected all of the symbols and/or a suitable number of symbols. Referring to the example code of FIG. 5 and Equation (1), there are five unknowns and six equations. Hence, as long as the coding matrix, as derived from the graph shown in FIG. 5, is selected properly, the receiver/decoder may be able to solve the message symbols Xᵢ straightforwardly, for example, using a Gaussian elimination (GE) algorithm. In some embodiments, the transmitter will keep sending the coded domain symbols Zᵢ as long as the transmitter has a new message to be transmitted and/or the message is no longer valid. In some embodiments, the receivers are collecting coded domain symbols as long as they are available and/or the decoder is able to retrieve the message correctly. In some embodiments, as a result of employing fountain codes, explicit retransmissions of packets based on acknowledgement and/or retransmission requests may be reduced and/or eliminated. Without using fountain codes and/or a similar coding technique, if multiple receivers are employed, these receivers may flood the network with retransmission requests, which may degrade performance of the mixed-reality service. Further, Li-Fi transmission of a mixed-reality service may not have a backchannel.

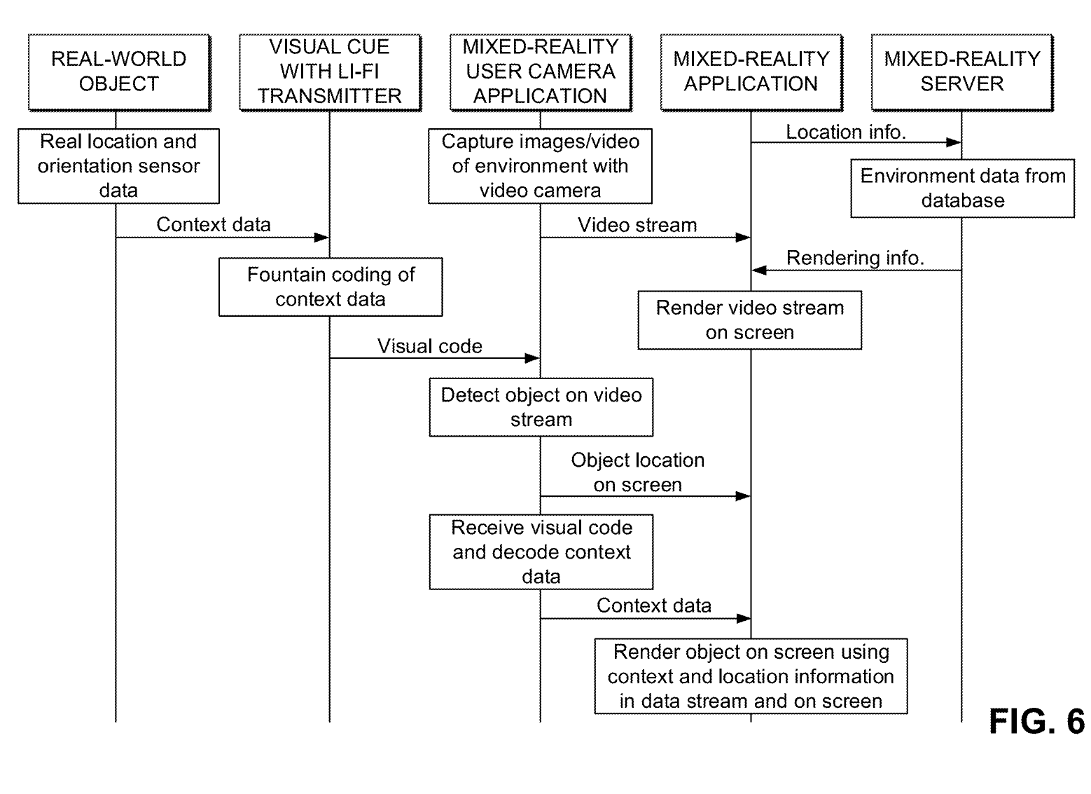

FIG. 6 is a flow diagram of an exemplary data flow/data processing that may be used for rendering a mixed-reality object on a service user's display (e.g., screen). As set forth above, in some embodiments, the proxy object is equipped with sufficient sensor instrumentation to measure the location and/or orientation of the (real-world) object. If the object is a complicated shape (e.g., has moving parts), some of the sensors may obtain additional measurements, such as, for example, measurements corresponding to motion of one or more joints and/or limbs of the object. In addition, the proxy object may be equipped to collect relevant contextual data, for example, corresponding to desired shape, texture, and possible rendering schemes in the mixed-reality environment.

In some embodiments, the data packet is handled with a Li-Fi based light-emitting element that applies coding (e.g., fountain coding) to transmit the data to the one or more receivers. The visual code may be received by one or more camera applications that are pointed towards the object. The receiving camera may detect the object from the light-emitting element. For example, the camera application may detect the location of the light-emitting element in the field of view, may read the visual code, and/or may detect the shape of the object on the video stream. The object location, shape, and/or motion data may be delivered to the mixed-reality application. The visual code read on the screen may be decoded and/or the corresponding context data may be forwarded to the application.

As an example, in some embodiments, the light-emitting element may transmit characteristic data corresponding to a length of the corresponding real-world object, and the mixed-reality system may select a type of virtual object based on transmitted the length data. For example, the light-emitting element may transmit a modulated light signal which indicates that the length of the corresponding real-world object is 0.2 m long. Further to this example, after receiving the transmitted modulated light signal, the mixed-reality service, which implements a mixed-reality game allowing users to play (e.g., individually and/or collectively) a variety of sports, may select a virtual table-tennis paddle (as opposed to a virtual tennis racquet) and overlays an image of the selected virtual table-tennis paddle at the position of the real-world object. However, if the light-emitting element transmitted a modulated light signal indicating the length of the corresponding real-world object as 0.7 m, the mixed-reality service may select a virtual tennis racquet as an overlay to display at the position of the real-world object.

In some embodiments, the light-emitting element may transmit characteristic data corresponding to a material and/or texture of the corresponding real-world object, and the mixed-reality system may select a type of virtual object based on the transmitted material and/or texture data. For example, the light-emitting element may transmit a modulated light signal which indicates that the material of the corresponding real-world object is aluminum. Further to this example, after receiving the transmitted modulated light signal, the mixed-reality service, which implements a mixed-reality game allowing users (e.g., individually and/or collectively) to play a variety of sports, may select a virtual aluminum baseball bat (as opposed to a virtual wooden baseball bat). However, if the light-emitting element transmitted a modulated light signal indicating that the material of the corresponding real-world object is wood, the mixed-reality service may have selected a virtual wooden baseball bat to overlay at the position of the real-world object.

The mixed-reality application may “bring the object to life” and/or create a mixed-reality identity for the object. In some embodiments, for the mixed-reality application to perform such an operation, the mixed-reality application may receive the absolute location of the real-world object (e.g., based on GPS coordinates or locally-defined coordinates), context information regarding a selected shape, orientation, motion, texture, animations, etc., for rendering the real-world object in the mixed-reality world, and the location of the object on the screen.

In some embodiments, the context data the object transmits may contain only minimum information on location/orientation and may contain the object identity. In such embodiments, the object identity can be applied to request further details of the object from one or more of the mixed-reality server databases. For example, the mixed-reality application may use the identity code to request further information corresponding to the identity code from the server database. The database may contain pre-recorded information, for example, regarding the rendering scheme that may be employed by the mixed-reality application to render the virtual object. This information may be returned to the application in response to a querying the database using the identity code.

When the relevant information (e.g., the relative position and/or orientation of the object, the shape of the object, the desired rendering scheme, etc.) is available/accessible, for example, directly in the transmission code from the object or from the server, the application may render the virtual object on the screen on top of the physical object seen in the video stream. Accordingly, the rendered object may be an overlay on top of the captured video stream.

In some scenarios, fountain codes may be useful for the point-to-multipoint communications. For example, fountain codes may be useful for transmitting contextual information using Li-Fi technology from a light-emitting element to a camera application (e.g., when there is no physical backchannel to the object). Fountain codes and/or Luby transforms may be used in other scenarios, such as, for example, multimedia streaming applications which may apply Raptor codes and/or Tornado codes.

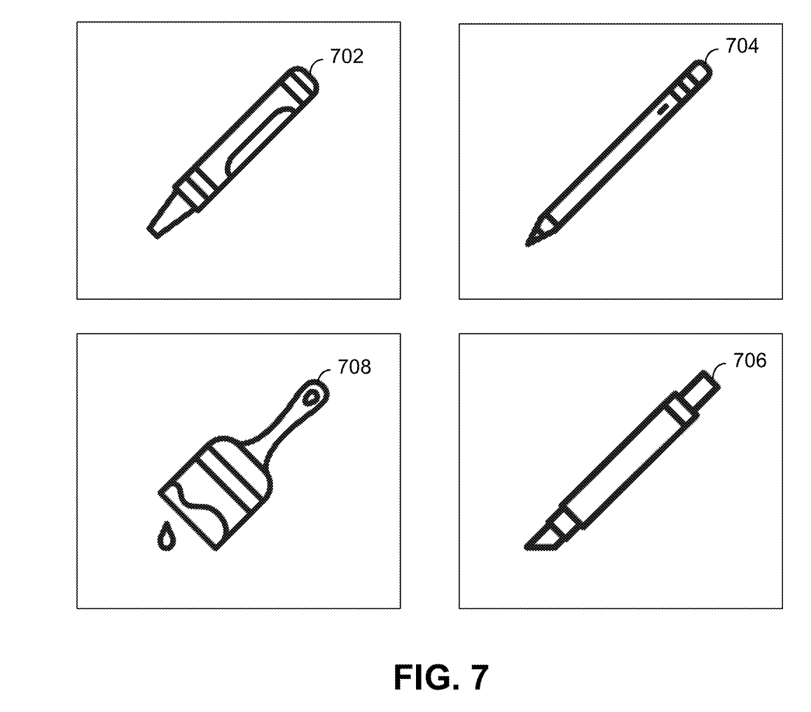

In some embodiments, the same real-world object may have a different appearance for different users of the mixed-reality service (e.g., different game players of a mixed-reality game). For example, when a mixed-reality game applies the object identity for retrieving the relevant context information from the game server, the information could be tailored (e.g., have a unique appearance) for each game player individually. In some embodiments, the same real-world object may have a different appearance for different portions of content of the mixed-reality service (e.g., different levels of a mixed-reality game). FIG. 7 illustrates various virtual objects. A virtual crayon 702, a virtual pencil 704, a virtual pen 706, and a virtual paint brush 708 all correspond to the same real-world object having a light-emitting element mounted thereto, but these virtual objects are all different virtual objects. In the example shown in FIG. 7, a user interacting with the same real-world object is playing a virtual-reality game in which the user can create various artworks using a variety of tools. In this example, the same real-world object may be rendered as the virtual crayon 702 during a first level of the game, the same real-world object may be rendered as the virtual pencil 704 during a second level of the game, the same real-world object may be rendered as the virtual pen 706 during a third level of the game, and the same real-world object may be rendered as the virtual paint brush 708 during a fourth level of the game. The user or mixed reality user application may additionally or alternatively select the virtual object to be rendered by inputting user-input data or other data (e.g., as explained above with respect to FIG. 1). The user application may conduct the selection automatically based on the application settings or application context.

In some embodiments, the information may be the same for more than one and/or all of the game players. For example, if the object is configured to transmit the context information itself and/or when a new object appears in the game, the information may be the same for every game player. Some game applications may have different interpretations for the same context information. For example, users (e.g., game players) may have different preferences to color and/or animation schemes. In that example, the received context information is applied differently. Device capabilities may limit the feasibility of certain rendering techniques (e.g., to render special animations). For example, the animated flames of the virtual torch in FIG. 2, may be disabled in low end devices and/or the virtual torch may be replaced with a virtual light source (e.g., a virtual flash light).

In some embodiments, each of the mixed-reality service users experience the environment through a head-mounted display/device (HMD). The HMD may be configured to capture the environment with a video camera. A video stream may then be presented to the user via goggles in a near field display. Oculus virtual-reality equipment is an example of such a platform.

Physical objects in the mixed-reality service environment may be marked with light-emitting elements in such a manner that both the user equipment and the camera application detect the light-emitting elements. The mixed-reality application may replace the objects on which the light-emitting elements are attached with an artificial shape and/or texture.

The light-emitting element may transmit contextual information using Li-Fi technology to the receiving camera application. The mixed-reality service application may utilize this information and/or may render an overlay according to the received instructions.

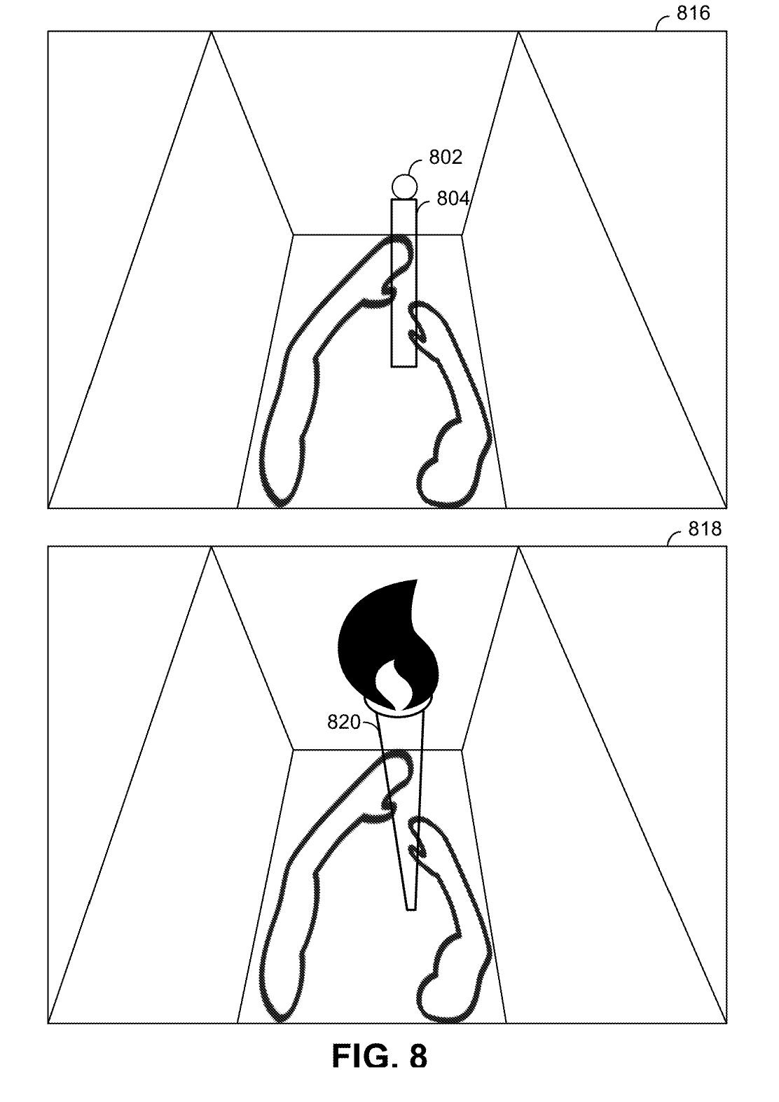

FIG. 8 illustrates an embodiment in which an image of a proxy object on a camera view is replaced with an artificial shape and texture. In FIG. 8, a camera view of a real-world environment is shown at 816 and a view of a virtual environment is shown at 818. The proxy object includes a physical object 804 and is equipped with one or more light-emitting elements 802. In some embodiments, a light-emitting element attached to or mounted on an object may include only a single light source. For example, if the light-emitting element is able to communicate the shape and movement of the object, then the light-emitting element may include a single light source. In some such embodiments, there may be no need to trace several light-emitting elements with a stereo camera. When the message is coded, losing one light-emitting element out of sight does not mean losing, for example, the orientation information.

Because the light-emitting element may correspond to the location of the object on which the light-emitting element is mounted, the location of the object may be detected on the video stream. The visual code received by the camera or with special detector hardware may then be decoded. The received location and/or orientation information may be applied to determine the relative motion of the object to the receiver. This may enable the application to render the object correctly on the screen. The application may remove everything from the captured video stream and/or may render an artificial object on the same location the video contained the real world object(s). Accordingly, the physical real world object may be replaced by an artificial overlay. In some embodiments, the shape and texture of the rendered object may be enhanced by visual effects that are based on a rendering instruction in the received message. In some embodiments, where the message does not contain this information but contains the object identity, the same information may be retrieved from the service database.

In some embodiments, the mixed-reality service includes a plurality of different objects, each mounted on or otherwise attached to a corresponding one or more light-emitting elements. Additionally, in some embodiments, the environment in which the mixed-reality service is operated may also be provided with one or more light-emitting elements. For example, such an environment may include one or more light-emitting elements mounted on a wall, floor, and/or ceiling of the environment.

Samsung Gear VR, Oculus and Microsoft Hololens are platforms on top of which mixed-reality services and/or games can be built. For example, multi-player and/or social aspects may be included on such platforms. For such use-scenarios, having a reliable technique for detection and recognition of objects on the screen may be useful. Efficient methods for building mixed-reality functionality may be desired by some developers. For example, all the objects in the service may not be defined and specified beforehand; instead the object appearing for the users will communicate the rendering instructions independently.

Exemplary embodiments disclosed herein are implemented using one or more wired and/or wireless network nodes, such as a wireless transmit/receive unit (WTRU) or other network entity. For example, an augmented reality display device may be implemented using a WTRU.

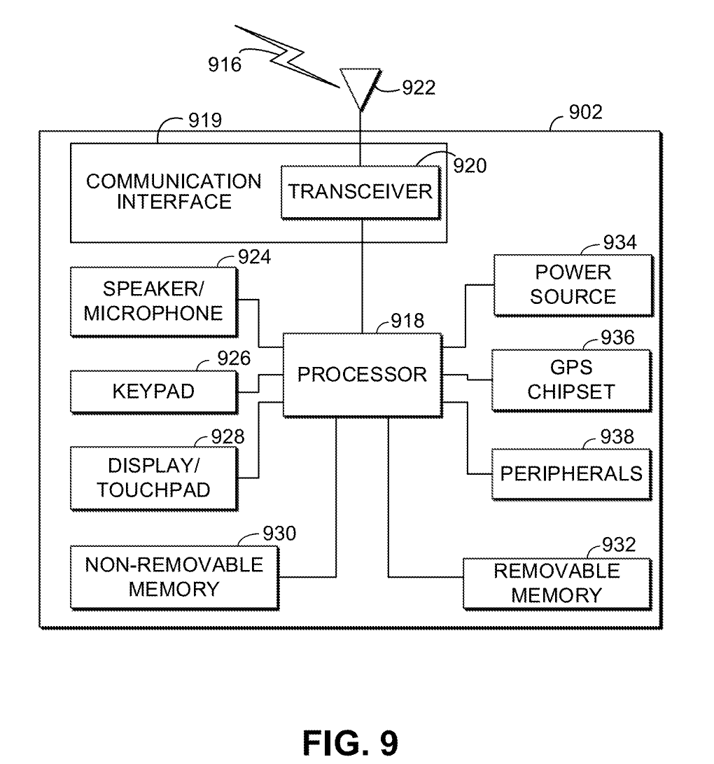

FIG. 9 is a system diagram of an exemplary WTRU 902, which may be employed as a system, implemented on an HMD, in one or more embodiments described herein. As shown in FIG. 9, the WTRU 902 may include a processor 918, a communication interface 919 including a transceiver 920, a transmit/receive element 922, a speaker/microphone 924, a keypad 926, a display/touchpad 928, a non-removable memory 930, a removable memory 932, a power source 934, a global positioning system (GPS) chipset 936, and sensors 938. It will be appreciated that the WTRU 902 may include any sub-combination of the foregoing elements while remaining consistent with an embodiment.

The processor 918 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 918 may perform signal coding, data processing, power control, input/output processing, and/or any other functionality that enables the WTRU 902 to operate in a wireless environment. The processor 918 may be coupled to the transceiver 920, which may be coupled to the transmit/receive element 922. While FIG. 9 depicts the processor 918 and the transceiver 920 as separate components, it will be appreciated that the processor 918 and the transceiver 920 may be integrated together in an electronic package or chip.

The transmit/receive element 922 may be configured to transmit signals to, or receive signals from, a base station over the air interface 916. For example, in one embodiment, the transmit/receive element 922 may be an antenna configured to transmit and/or receive RF signals. In another embodiment, the transmit/receive element 922 may be an emitter/detector configured to transmit and/or receive IR, UV, or visible light signals, as examples. In yet another embodiment, the transmit/receive element 922 may be configured to transmit and receive both RF and light signals. It will be appreciated that the transmit/receive element 922 may be configured to transmit and/or receive any combination of wireless signals.

In addition, although the transmit/receive element 922 is depicted in FIG. 9 as a single element, the WTRU 902 may include any number of transmit/receive elements 922. More specifically, the WTRU 902 may employ MIMO technology. Thus, in one embodiment, the WTRU 902 may include two or more transmit/receive elements 922 (e.g., multiple antennas) for transmitting and receiving wireless signals over the air interface 916.

The transceiver 920 may be configured to modulate the signals that are to be transmitted by the transmit/receive element 922 and to demodulate the signals that are received by the transmit/receive element 922. As noted above, the WTRU 902 may have multi-mode capabilities. Thus, the transceiver 920 may include multiple transceivers for enabling the WTRU 902 to communicate via multiple RATs, such as UTRA and IEEE 802.11, as examples.

The processor 918 of the WTRU 902 may be coupled to, and may receive user input data from, the speaker/microphone 924, the keypad 926, and/or the display/touchpad 928 (e.g., a liquid crystal display (LCD) display unit or organic light-emitting diode (OLED) display unit). The processor 918 may also output user data to the speaker/microphone 924, the keypad 926, and/or the display/touchpad 928. In addition, the processor 918 may access information from, and store data in, any type of suitable memory, such as the non-removable memory 930 and/or the removable memory 932. The non-removable memory 930 may include random-access memory (RAM), read-only memory (ROM), a hard disk, or any other type of memory storage device. The removable memory 932 may include a subscriber identity module (SIM) card, a memory stick, a secure digital (SD) memory card, and the like. In other embodiments, the processor 918 may access information from, and store data in, memory that is not physically located on the WTRU 902, such as on a server or a home computer (not shown).

The processor 918 may receive power from the power source 934, and may be configured to distribute and/or control the power to the other components in the WTRU 902. The power source 934 may be any suitable device for powering the WTRU 902. As examples, the power source 934 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 918 may also be coupled to the GPS chipset 936, which may be configured to provide location information (e.g., longitude and latitude) regarding the current location of the WTRU 902. In addition to, or in lieu of, the information from the GPS chipset 936, the WTRU 902 may receive location information over the air interface 916 from a base station and/or determine its location based on the timing of the signals being received from two or more nearby base stations. It will be appreciated that the WTRU 902 may acquire location information by way of any suitable location-determination method while remaining consistent with an embodiment.

The processor 918 may further be coupled to other peripherals 938, which may include one or more software and/or hardware modules that provide additional features, functionality and/or wired or wireless connectivity. For example, the peripherals 938 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 938 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

In the present disclosure, various elements of one or more of the described embodiments are referred to as “modules” that carry out (i.e., perform, execute, and the like) various functions described herein. As the term “module” is used herein, each described module includes hardware (e.g., one or more processors, microprocessors, microcontrollers, microchips, application-specific integrated circuits (ASICs), field programmable gate arrays (FPGAs), memory devices, and/or one or more of any other type or types of devices and/or components deemed suitable by those of skill in the relevant art in a given context and/or for a given implementation. Each described module also includes instructions executable for carrying out the one or more functions described as being carried out by the particular module, where those instructions could take the form of or at least include hardware (i.e., hardwired) instructions, firmware instructions, software instructions, and/or the like, stored in any non-transitory computer-readable medium deemed suitable by those of skill in the relevant art.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

### Alternative Embodiments

An alternative embodiment takes the form of a method for communicating proxy object information in a mixed-reality service. The method includes detecting a first temporal light modulation from a light-pattern emitting proxy object. The method also includes rendering a first virtual object using a head-mounted display at a first virtual position corresponding to a detected position of the light-pattern emitting proxy object. The method also includes responsive to detecting a second temporal light modulation from the light-pattern emitting proxy object, rendering a second virtual object using the head-mounted display at a second virtual position corresponding to a detected position of the light-pattern emitting proxy object, where the second virtual object is different from the first virtual object.

In at least one alternative embodiment, the first virtual object corresponds to the first temporal light modulation and the second virtual object corresponds to the second temporal light modulation.

In at least one alternative embodiment, the second virtual object is a next item in a virtual inventory from the first virtual object.

Another alternative embodiment takes the form of a method for communicating proxy object information for use in a mixed-reality service. The method includes detecting a coded visible-light-communication (VLC) signal transmitted via a light-emitting element mounted to a proxy object, the coded VLC signal being encoded with object identification information of the proxy object. The method also includes determining a first position in a virtual environment based on the detected coded VLC signal. The method also includes decoding the detected coded VLC signal to obtain the object identification information. The method also includes rendering a first virtual object at the first position in the virtual environment, the rendering being based on the object identification information.

In at least one alternative embodiment, the object identification information includes at least one of shape data, orientation data, motion data, texture data, and/or animation data for rendering the first virtual object.

In at least one alternative embodiment, the method further includes retrieving, based on the object identification information of the light-emitting element, object characteristic data corresponding to the light-emitting proxy object from a database of object characteristic data.

In at least one alternative embodiment, the object identification information includes at least one of position data and/or orientation data.

In at least one alternative embodiment, the first coded VLC signal transmitted via the light-emitting element is transmitted via light-fidelity (Li-Fi) technology.

In at least one alternative embodiment, the first coded VLC signal is coded using a fountain coding technique.

Another alternative embodiment takes the form of a system for communicating proxy object information for use in a mixed-reality service. The system includes a proxy object. The system also includes a light-emitting element mounted to the proxy object, the light-emitting element configured to transmit a coded visible-light-communication (VLC) signal to each entity of a set of one of more entities in mixed-reality service, the coded VLC signal being encoded in such a way to enable each entity in the set of one or more entities in the mixed-reality service to determine a location of the proxy object and render the proxy object based on predetermined characteristics.

Another alternative embodiment takes the form of a method. The method includes transmitting a modulated virtual light signal via a light-emitting element. The method also includes rendering a virtual object corresponding to a real-world object mounted to the light-emitting element.

Another alternative embodiment takes the form of a mixed-reality method. The method includes using a camera, detecting an image of a proxy object. The method also includes based at least in part on the image, determining a position of the proxy object. The method also includes using the camera, detecting a temporally-modulated coded light signal from a light-emitting element on the proxy object. The method also includes selecting a virtual object based at least in part on the coded light signal. The method also includes, on a mixed-reality display, rendering the selected virtual object at the determined position of the proxy object.

In at least one alternative embodiment, the coded light signal encodes a physical property of the proxy object, and wherein the virtual object is selected to correspond to the encoded physical property of the proxy object. In at least one such embodiment, the physical property includes a length of the proxy object. In at least one such embodiment, the physical property includes a weight of the proxy object.

In at least one alternative embodiment, the coded light signal encodes an identifier of the proxy object.

In at least one alternative embodiment, the coded light signal is encoded using a fountain code.

Another alternative embodiment takes the form of a mixed-reality service. The mixed-reality service includes a camera. The mixed-reality service also includes a mixed-reality display. The mixed-reality service also includes a processor. The mixed-reality service also includes a non-transitory computer-readable medium storing instructions operative, when executed on the processor, to perform functions including: operating the camera to detect an image of a proxy object; based at least in part on the image, determining a position of the proxy object; operating the camera to detect a temporally-modulated coded light signal from a light-emitting element on the proxy object; selecting a virtual object based at least in part on the coded light signal; and on the mixed-reality display, rendering the selected virtual object at the determined position of the proxy object.

In at least one alternative embodiment, the mixed-reality service further includes a high-speed photodiode and analog-digital converter.

Another alternative embodiment takes the form of a proxy object. The proxy object includes a memory storing an identifier of the proxy object. The proxy object also includes a motion sensor operative to generate motion data. The proxy object also includes a light-emitting element operative to transmit a modulated light signal, wherein the modulated light signal encodes at least the identifier of the proxy object and the motion data.

In at least one alternative embodiment, the motion sensor comprises at least one gyroscope.

In at least one alternative embodiment, the motion sensor comprises at least one accelerometer.

In at least one alternative embodiment, the memory further stores a physical property of the proxy object, and wherein the modulated light signal further encodes the physical property of the proxy object.

In at least one alternative embodiment, the light-emitting element employs fountain coding.

1. A method comprising:
at a head-mounted display, detecting a first temporally-modulated light signal emitted from a light-pattern emitting real-world proxy object;
decoding the first light signal to identify a virtual object indicated by the first light signal;
tracking a location of the proxy object;
rendering the identified virtual object on the head-mounted display at a position corresponding to the position of the proxy object;
detecting a second temporally-modulated light signal emitted from the proxy object, wherein the proxy object switches from emitting the first light signal to emitting the second light signal in response to a user input on the proxy object;
decoding the second light signal to identify a second virtual object indicated by the second light signal; and
switching from rendering of the first virtual object to rendering of the second virtual object on the head-mounted display at the position corresponding to the position of the proxy object.

2. The method of claim 1, wherein the head-mounted display includes a camera, and wherein tracking the location of the proxy object is performed using an image of the proxy object captured by the camera.

3. The method of claim 2, wherein detecting the first light signal is performed using the camera.

4. The method of claim 2, wherein detecting the first light signal comprises extracting light-signal data indicative of the first light signal from the image of the proxy object captured by the camera.

5. The method of claim 1, wherein the light signal is a visible light signal.

6. The method of claim 1, wherein the first light signal is encoded using a fountain code, and wherein decoding the first light signal comprises decoding the fountain code.

7. The method of claim 1, wherein decoding the first light signal comprises:
extracting a virtual object identifier from the first light signal; and
using the virtual object identifier, retrieving from a database parameters for rendering the identified virtual object.

8. The method of claim 1, wherein decoding the first light signal comprises extracting from the first light signal parameters for rendering the identified virtual object.

9-10. (canceled)

11. The method of claim 1, further comprising:
at the head-mounted display, detecting a third temporally-modulated light signal emitted from a second light-pattern emitting proxy object, wherein the third light signal is detected while the first light signal is detected;
decoding the third light signal to identify a third virtual object indicated by the third light signal;
tracking a location of the second proxy object; and
rendering with the first virtual object the identified third virtual object on the head-mounted display at a position corresponding to the position of the second proxy object.

12. The method of claim 1, wherein the first light signal encodes object-selection data indicative of a user selection of the virtual object from an inventory of virtual objects.

13. The method of claim 1, wherein the first light signal encodes length data indicative of a length of the proxy object, and wherein the identified virtual object is rendered to include a virtual property corresponding to the length of the proxy object.

14. A system comprising:
a head-mounted display;
a processor;
a non-transitory storage medium storing instructions operative, when executed by the processor, to perform the functions of:
at the head-mounted display, detecting a first temporally-modulated light signal emitted from a light-pattern emitting real-world proxy object;
decoding the first light signal to identify a virtual object indicated by the first light signal;
tracking a location of the proxy object;
rendering the identified virtual object on the head-mounted display at a position corresponding to the position of the proxy object;
detecting a second temporally-modulated light signal emitted from the proxy object;
decoding the second light signal to identify a second virtual object indicated by the second light signal; and
switching from rendering of the first virtual object to rendering of the second virtual object on the head-mounted display at the position corresponding to the position of the proxy object.

15. The system of claim 14, further comprising a camera, wherein tracking the location of the proxy object is performed using an image of the proxy object captured by the camera.

16. The system of claim 15, wherein detecting the light signal is performed using the camera.

17. The system of claim 14, wherein the light signal is a visible light signal.
